(19) United States
(12) Patent Application Publication
(10) Pub. No.: US 2026/0298260 A1
(43) Pub. Date: Oct. 1, 2026

(54) VARIABLE-PITCH VANE FOR AN UNDUCTED AERONAUTICAL THRUSTER

(71) Applicant: SAFRAN AIRCRAFT ENGINES, PARIS (FR)

(72) Inventors: Guillaume Claude Robert BELMON, MOISSY-CRAMAYEL (FR); David Jacques Georges VANPOUILLE, MOISSY-CRAMAYEL (FR); Julien Michel TAMIZIER, MOISSY-CRAMAYEL (FR); Myriam Amanda QUARANTA, MOISSY-CRAMAYEL (FR)

(21) Appl. No.: 19/479,216

(22) PCT Filed: Apr. 23, 2024
(86) PCT No.: PCT/FR2024/050526

§ 371 Date: Oct. 27, 2025

(30) Foreign Application Priority Data
Apr. 28, 2023 (FR) FR2304303

(51) Int. Cl. F04D 29/56; B64D 27/10

(52) U.S. Cl. CPC F04D 29/384; B64C 11/18; F04D 29/563; B64D 27/10; F05D 2240/121; F05D 2240/303

(57) ABSTRACT

A variable pitch vane for unducted aeronautical thruster comprising a blade defining a leading edge, a trailing edge and lower and upper surfaces, the vane having a median line, a thickness of the leading edge defined as the length of a first segment cutting the median line at a first point located at 0.2% of the total length of the median line, and a separation-zone thickness defined as a length of a second segment cutting the median line at a second point located at 5% of the total length of the median line. For each section plane, the ratio between the separation-zone thickness and the leading-edge thickness is included between 2.5 and 8.

### FIELD OF THE INVENTION

The invention relates to a variable pitch vane for unducted aeronautical thruster, and also a turbomachine comprising such vanes.

### DESCRIPTION OF RELATED ART

The search for minimizing polluting emissions related to aerial transport goes in particular through the improvement of the efficiency of propulsion systems, and more specifically the propulsive yield which characterizes the efficiency with which the energy which is communicated to the air which passes through the engine is converted into a thrust force useful for propulsion.

A known principle serving to improve the propulsive yield consists of modifying the elements of the low-pressure system of the thrusters, which directly contribute to the generation of the thrust, in combination with other known elements of the turbomachine, like the high-pressure body and the combustion chamber. These elements typically comprise a low-pressure turbine, a low-pressure transmission system driving a fan, and a secondary flow straightener guiding the flow thereof. One solution aims to reduce the compression rate of the fan, thereby reducing the outlet flow speed of the engine and the kinetic energy losses which are related to it.

One of the main consequences of this reduction of outlet flow speed is that it is necessary to make a greater mass flow rate of air pass through the low-pressure part (or secondary flow) in order to get a given thrust level. This therefore leads to an increase of the dilution rate of the engine (or BPR, Bypass Ratio), defined as the ratio between the mass flow rate passing in the secondary flow (cold flow), and the mass flow rate passing in the primary flow (hot flow) and in particular supplying the combustion chamber.

The very large fan diameters necessary for such a dilution would lead to a very large increase of the dimensions of the housing and the nacelle, leading to the development of unducted turbomachines to remedy this problem.

FIG. 1 shows such an unducted turbomachine 1, of the type designated by the acronym USF (Unducted Single Fan). The turbomachine 1 comprises an upstream propeller wheel 3 (or rotor 3) with variable pitch and a downstream straightener wheel 5 (or stator 5) with fixed or variable pitch.

The terms “upstream” and “downstream” are understood relative to a main axis X of the turbomachine 1 which is coincident with the axis of rotation of the rotor 3 and relative to a normal direction of flow of the air during operation of the turbomachine 1.

The turbomachine 1 is in “puller” type configuration, meaning with the rotor 3 and the stator 5 upstream from the turbine, and is generally mounted on the fuselage or under a wing of the aircraft by a pylon 7. Alternatively, a turbomachine may have a configuration called “pusher” with the propellers downstream from the turbine for a mounting at the rear of the aircraft.

The rotor 3 and the stator 5 each comprise a plurality of vanes 10 distributed circumferentially around the main axis X.

The rotor 3 is a propeller mobile in rotation around the axis X so as to drive air and generate a primary flow Fp sent into the turbomachine and a secondary flow Fs flowing outside of the turbomachine.

This rotor 3 is a variable pitch and slow rotation regime propeller, meaning that each vane 10 comprises a blade mounted rotationally mobile around a radial axis, so as to modify the pitch angle thereof for maximizing the thrust according to the flight stage (takeoff, cruising, landing, etc.), where the slow rotation speed serves to maximize the energy yield of the thruster. Such an unducted turbomachine does not comprise an external housing surrounding the secondary flow Fs. Only the primary flow Fp is guided in a central housing of the turbomachine.

The acoustic attenuation of the noise generated by the turbomachine is greatly reduced, in particular for low frequencies (below 500 Hz). The allowable noise levels are greatly constrained, in particular for the takeoff and landing phases, which involves an optimization of the vanes for reducing the noise level, since there is no access to conventional solutions for attenuation of the ducted turbomachines.

Finally, the blades of the variable pitch vanes, in an unducted turbomachine, are particularly sensitive to the nonuniform airflow, with non-axial incidence, meaning forming a nonzero angle with the direction of the main axis X of the turbomachine because there is no external housing guiding the secondary flow. Such airflows particularly appear during aircraft takeoff and landing phases and may generate transverse forces and moments in the plane of the propeller. These forces are transitory and vary for each blade during its rotation, with differences according to the rising and descending position of the blade. Consequently, over one turn of the engine, a single propeller blade is subject to variable forces dependent on the azimuthal position thereof. The vanes of the stators located downstream from the propeller will also have a variable incidence according to their azimuthal position.

A known solution with which to reduce the noise level generated by the vanes is to uniformly reduce the radial length of the vanes of the wheel located downstream, meaning the stator 5 in the case shown. In this way, the impact of the vortices formed near the radially outer ends of the vanes of the rotor 3 on the vanes of the stator is limited in that these vortices pass radially to the outside of the stator vanes. This solution is called clipping or cropping or even truncation of the blades of the downstream wheel. A clipping rate can be defined as the ratio of the difference in radius between the rotor and the stator over the radius of the rotor, generally expressed as a percentage.

However, this solution may be further improved. In fact, a high clipping rate notably reduces the propulsive yield of the turbomachine. Further, the noise reduction is especially effective at zero incidence and does not necessarily allow a satisfactory result in situations of large incidence.

### BRIEF SUMMARY OF THE INVENTION

The invention aims to remedy these drawbacks by proposing an unducted turbomachine robust to incidence variations of the airflows over various operating points corresponding to various phases of flight, and offering a satisfactory aerodynamic and acoustic behavior for a wide range of rotation speeds.

For this purpose, the object of the invention is a variable pitch vane for unducted aeronautical thruster, comprising a blade extending along a blade axis, from a foot to an apex of the blade, where the blade defines a leading edge, a trailing edge, and lower and upper surfaces extending from the leading edge to the trailing edge;

where the blade comprises, in any section plane orthogonal to the blade axis:
a median line extending from the leading edge to the trailing edge, equidistant from the lower surface and the upper surface, having a total length measured along the median line from the leading edge to the trailing edge;
a leading-edge thickness, defined as a length of a first segment extending from the lower edge to the upper edge and cutting perpendicularly to the median line at a first point of the median line located at a distance from the leading edge, measured along the median line, equal to 0.2% to the total length of the median line;
a separation-zone thickness, defined as a length of a second segment extending from the lower edge to the upper edge and cutting perpendicularly to the median line at a second point of the median line located at a distance from the leading edge, measured along the median line, equal to 5% to the total length of the median line;

characterized in that, for each section plane orthogonal to the blade axis, the ratio between the separation-zone thickness and the leading-edge thickness is included between 2.5 and 8. Such a vane serves to greatly limit the aerodynamic flow separation near the leading edge of the propellers when they operate at low speed and with a high incidence for reaching the target thrust during the takeoff phase of the aircraft. This then greatly reduces the formation of a downstream vortex, which otherwise constitutes a propeller wake that is very energy wasting and acoustically very penalizing.

For each section plane orthogonal to the blade axis, the ratio between the separation-zone thickness and the leading-edge thickness may be included between 3.5 and 5.

Such a feature allows a better compromise between the robustness of the blade to incidence variations and aerodynamic effectiveness.

On a lower portion of the blade extending from the foot over a height included between 0% and 35% of the total height of the blade measured between the foot and the apex, for each section plane of said lower portion, the ratio between the separation-zone thickness and the leading-edge thickness may be included between 3 and 8.

Such a feature serves to improve the robustness to incidence variations in particular on the blade bottom, which generates the primary flow feeding the turbine in the case of the rotor, and therefore requires less performance of the blade whatever the flight domain, or in the case of the stator, which takes up the most thrust.

On an upper portion of the blade extending to the apex over a height included between 35% and 100% of the total height of the blade measured between the foot and the apex, for each section plane of said upper portion, the ratio between the separation-zone thickness and the leading-edge thickness may be included between 2.5 and 5.

Such a feature serves to optimize the aerodynamic performance of the blade over the high part while also maintaining sufficient robustness to incidence variations and satisfactory acoustical performance.

The ratio between the separation-zone thickness and the leading-edge thickness for any section plane of the lower portion of the blade extending from the foot over a height included between 0% and 35% of the total height of the blade measured between the foot and the apex may be greater than or equal to the ratio between the separation-zone thickness and the leading-edge thickness for any section of an upper portion of the blade extending to the apex over a height included between 35% and 100% of the total height of the blade.

Such a feature serves to distribute the aerodynamic performance of the blade over the most critical parts and to improve the incidence robustness of the lower parts of the blade. Such a variation of the aerodynamic performance of the blade is particularly advantageous for a dual flow thruster, by optimizing the lower part of the blade for a good supply of the primary flow radially inside and by making it possible to have different features for the upper part of the blade, better suited to supplying the secondary flow, radially outside.

The blade may comprise, in each section plane orthogonal to the blade axis, a maximum thickness, defined as the length of a third segment extending from the lower edge to the upper edge and cutting the median line perpendicularly at a third point, for which the third segment length is a maximum over an extent of the median line, and

wherein said third point is located at a distance from the leading edge, measured along the median line, greater than or equal to 15% and advantageously included between 15% and 40% of the total length of the median line.

Such a feature serves to separate the maximum thickness of the leading edge and thus improve the performance of the blade.

The ratio may be strictly increasing from the leading edge to the third point and strictly decreasing from said third point to the trailing edge.

The vane may be a rotor vane mounted on a disk mobile in rotation around a main axis.

The invention also relates to an unducted thruster for aircraft, comprising at least one rotor and one stator, separated along a main axis of the thruster, where at least one among the rotor and the stator comprises a plurality of vanes, as above, distributed circumferentially about the main axis, in particular between 3 and 25 vanes, advantageously between 8 and 16 vanes.

Such a number of vanes constitutes an advantageous compromise between the energy performance of propulsion and the noise generated.

Between the rotor and the stator, the one placed upstream relative to the main axis may comprise at least two vanes more than the one placed downstream.

Such a feature serves to reduce the noise of the turbomachine. In fact, in the case where the number of blades of the rotor and the stator are equal, the combined wakes of the rotor interact with the blades of the stator simultaneously, which increases the noise levels.

The stator may be arranged downstream and have a clipping rate included between 5% and 15% and particularly between 7% and 12%.

Such a feature allows an additional reduction of the noise generated near the stator, without substantially reducing the propulsive yield of the turbomachine.

The lengths of the vanes of the stator may be inhomogeneous, with vane lengths in the lower parts of the stator, less than vane lengths in the upper parts of the stator.

Such a feature makes it possible to have a greater clipping rate below the stator, there where the noise generated is greater and therefore where the noise reduction is the most necessary, and a smaller clipping in the upper part, their word is less required. Thus, the compromise between noise reduction and propulsive yield is improved.

Each blade may have a chord length defined as the maximum over an extent of the blade for a distance between the leading edge and the trailing edge in a section plane transverse to the blade axis,

where the rotor and the stator have separations between neighboring blades, measured along the circumferential direction,

wherein a solidity of the rotor and the stator, defined as the ratio of the chord length over the separation between the neighboring blades, may be less than or equal to 3, and specifically less than or equal to 1 for the one placed the farthest upstream of the rotor and the stator, relative to the main axis.

A ratio between an axial distance separating the rotor and the stator and an outer diameter of the rotor may be included between 0.01 and 0.5, preferably between 0.15 and 0.35.

Such a feature provides an effective straightening by the stator of the flow leaving the rotor and improves the aerodynamic performance of the thruster.

### BRIEF DESCRIPTION OF THE DRAWINGS

FIG. 1 is a side view of an unducted turbomachine according to the invention;

FIG. 2 is a side view of a rotor vane from the turbomachine from FIG. 1;

FIG. 3 is a transverse section view of the vane from FIG. 2; and

FIG. 4 is a transverse section profile of the vane from FIGS. 2 and 3.

### DETAILED DESCRIPTION OF THE INVENTION

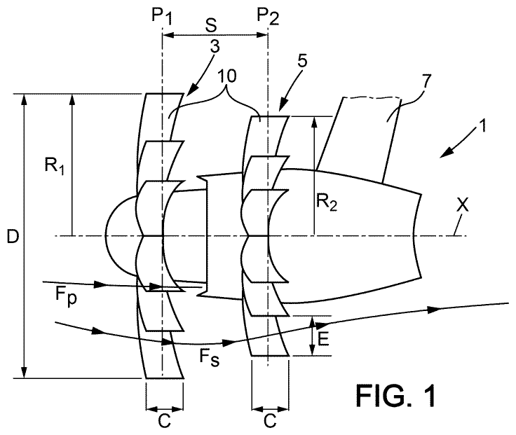

An unducted turbomachine 1 is shown in FIG. 1 defining a central axis X and comprising a rotor 3 and a stator 5 separated along the main axis X. The stator 5 is positioned downstream from the rotor 3.

The turbomachine 1 also comprises at least one engine arranged in the internal space thereof, where said engine may be a thermal engine, in particular a turbomotor, turbojet or turboblower type, and/or an electric motor, and/or a hydrogen engine, and/or a hybrid engine comprising several of these technologies.

The rotor 3 and the stator 5 both comprise a plurality of vanes 10 extending substantially radially from the main axis X and distributed uniformly, circumferentially around the axis X. The vanes 10 of the rotor 3 may have different dimensions from the vanes 10 of the stator 5, particularly different blade lengths.

Advantageously, the rotor 3 comprises at least two vanes 10 more than the stator 5.

The rotor 3 has a radius R1 measured from the central axis out to an apex of each vane 10 of the rotor 3.

Similarly, the stator 5 has a radius R2 measured from the central axis out to an apex of each vane 10 of the stator 5.

According to an embodiment, the radius R2 of the stator 5 is less than the radius R1 of the rotor 3, in particular less than the radius R1 by between 5% and 15% of the value of R1 and in particular between 7% and 12% of the value of R1. In other words, the stator 5 has a clipping rate, as defined above, included between 5% and 15% and particularly between 7% and 12%. This clipping rate allows an additional reduction of the noise generated near the stator, but remains sufficiently moderate to not substantially reduce the propulsive yield of the turbomachine.

A diameter D of the turbomachine 1 is defined as twice the larger of the two radii R1 and R2. The vanes 10 are variable pitch vanes, meaning vanes whose blades are mobile in rotation around a radial axis in order to vary under control the pitch angle of each blade of the rotor 3 or stator 5.

The axes of rotation of the blades, or blade axes, of the vanes of the rotor 3 are included in a plane P1 perpendicular to the main axis X, and the axes of the blades of the stator 5 are included in a plane P2 perpendicular to the main axis X and spaced from plane P1 by a distance S measured along the main axis X.

In the case where the vanes of the stator 5 are fixed-pitch vanes, the plane P2 is defined near the center of gravity of the vanes 10.

Advantageously, the ratio S/D, between the axial distance S separating the planes P1 and P2, and therefore separating the rotor 3 from the stator 5, and the outer diameter of turbomachine 1 is included between 0.01 and 0.5, preferably between 0.15 and 0.35.

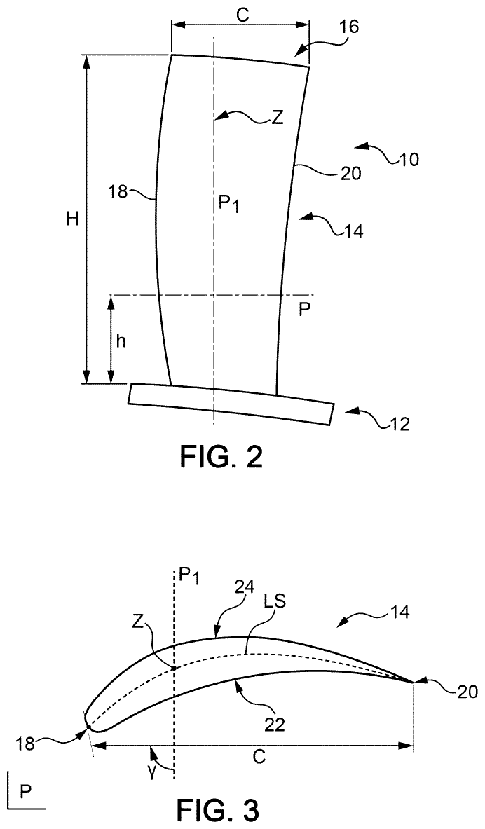

A vane 10 is shown in more detail in FIG. 2. The vane 10 comprises a foot 12, a blade 14 and an apex 16. The blade 14 extends along a blade axis Z perpendicular to the main axis X and is included in the plane P1 described above.

The blade 14 defines a leading edge 18 formed by the farthest upstream line of the blade 14 and a trailing edge 20 formed by the farthest downstream line.

The blade 14 comprises a lower surface 22 and an upper surface 24 extending from the leading edge to the trailing edge on either side of the blade 14.

A blade height H is defined as the distance measured along the blade axis Z separating the foot 12 from the apex 16 and a chord length C as the distance separating the leading edge 18 from the trailing edge 20 measured in a transverse section plane P.

A ratio called solidity TT=C/E is defined for the rotor 3 or for the stator 5 as the ratio between the length of the chord C measured at the apex 16 and a separation E between the apexes 16 of two neighboring vanes 10 of the rotor 3 or the stator 5.

Advantageously, the solidity is less than 3 for the rotor and the stator, and preferably less than 1 for the one placed further upstream, meaning the rotor 3 in the case shown.

A height h of a transverse section plane P is defined as the distance measured along the blade axis Z between the foot 12 and the section plane P.

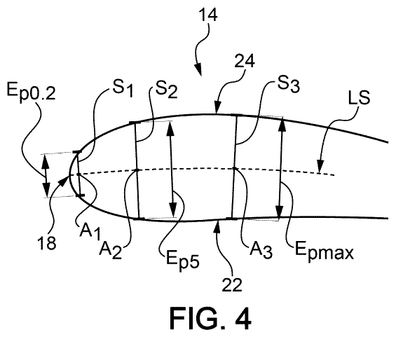

The FIGS. 3 and 4 show transverse sections of the blade 14 in a section plane P located at a height h.

In the plane P, a median line LS is defined as the curved line extending from the leading edge 18 to the trailing edge 20 and equidistant from the lower surface 22 and the upper surface 24. The length of the median line LS is strictly greater than the length of the chord C in the plane P which separates the leading edge 18 from the trailing edge 20 measured as a straight line. The pitch angle y of the blade 14 is shown as the angle between the chord C and the transverse plane P. The pitch angle y can be modified by rotation of the blade 14 around the blade axis Z.

As shown in FIG. 4, a thickness of the blade 14 is defined in the section plane P at a height h as the length of the segment perpendicular to the median line LS and extending from the lower edge 22 to the upper edge 24.

The thickness of the leading edge Ep0.2 is thus defined as the length of a first segment S1 which cuts the median line LS perpendicularly at a first point A1 located at a distance, measured along the median line LS, equal to 0.2% of the total length of the median line LS. Similarly, a separation-zone thickness Ep5 is defined as the length of a second segment S2 that cuts the median line LS perpendicularly at a second point A2 located at a distance, measured along the median line LS, equal to 5% of the total length of the median line LS.

The ratio R=Ep5/Ep0.2 between the thickness of the separation zone Ep5 and the thickness of the leading-edge Ep0.2 is characteristic of the performance of the blade and its robustness to incidence variations. In particular, small values of R correspond to high aerodynamic performance blades, whereas high values of R correspond to blades robust to the incidence. Thus, the values of R included between 2.5 and 8 offer an advantageous compromise, allowing a good performance for the blade while also reducing the takeoff risks and having satisfactory acoustical performance.

These minimum and maximum values of the ratio R are valid for any section plane P of the blade 14, meaning over the entire height H of the blade 14.

The behavior of the blade 14 is even more satisfactory for the values of R included between 3.5 and 5 over the full height H.

According to an advantageous embodiment, a lower part of the blade 14, for values of h included between 0 and 35% of the total height H is distinguished from an upper part of the blade, for values of height h included between 35% and 100% of the total height H of the blade 14.

Over the full lower part of the blade 14, the ratio R is advantageously included between 3 and 8, putting the emphasis on the resistance of the blade to incidence variations. In fact, the aerodynamic performance is less critical in the lower part, which concentrates the primary flow Fp towards the turbine.

Over the full upper part of the blade 14, the ratio R is advantageously included between 2.5 and 5 in order to emphasize the aerodynamic performance of the blade 14 over the upper part generating the secondary flow Fs.

Further, the ratio R over the full lower part is advantageously greater than the ratio R over the full upper part of the blade 14.

The application of these criteria is valid whatever the shape of the leading-edge zone, whether it is for a substantially circular leading-edge, or for a substantially asymmetric leading edge. As before, a maximum thickness Epmax is defined as the length of the third segment S3 which cuts the median lines at a third point A3 and for which the measured length is a maximum over the full median line.

Advantageously, the thickness of the blade varies monotonically from the leading edge to the maximum Epmax, then again monotonically from the maximum Epmax to the trailing edge. Preferably, the third point A3 is located at a distance from the leading edge, measured along the median line LS, greater than or equal to 15% of said total length of the median line LS. This serves to put the maximum thickness of the leading edge sufficiently far to have satisfactory performance. Still more preferably, the point A3 is located at a distance from the leading edge included between 15% and 40% of the total length of said median line LS.

1. A variable pitch vane (10) for unducted aeronautical thruster (1), comprising a blade (14) extending along a blade axis (Z), from a foot (12) to an apex (16) of the blade (14), where the blade (14) defines a leading edge (18), a trailing edge (20), and lower (22) and upper (24) surfaces extending from the leading edge (18) to the trailing edge (20); where the blade (14) comprises, in any section plane (P) orthogonal to the blade axis (Z):
a median line (LS) extending from the leading edge (18) to the trailing edge (20), equidistant from the lower surface (22) and the upper surface (24), having a total length measured along the median line (LS) from the leading edge (18) to the trailing edge (20);
a leading-edge thickness (Ep0.2), defined as a length of a first segment (S1) extending from the lower edge (22) to the upper edge (24) and cutting perpendicularly to the median line (LS) at a first point (A1) of the median line (LS) located at a distance from the leading edge (18), measured along the median line (LS), equal to 0.2% to the total length of the median line (LS);
a separation-zone thickness (Ep5), defined as a length of a second segment (S2) extending from the lower edge (22) to the upper edge (24) and cutting perpendicularly to the median line (LS) at a second point (A2) of the median line (LS) located at a distance from the leading edge (18), measured along the median line (LS), equal to 5% to the total length of the median line (LS);
characterized in that, for each section plane (P) orthogonal to the blade axis (Z), a ratio (R) between the separation-zone thickness (Ep5) and the leading-edge thickness (Ep0.2) is included between 2.5 and 8;
wherein the ratio (R) between the separation-zone thickness (Ep5) and the leading-edge thickness (Ep0.2) for any section plane (P) ofa lower portion of the blade (14) extending from the foot (12) over a height (h) included between 0% and 35% of the total height of the blade (14) measured between the foot (12) and the apex (16) is greater than or equal to the ratio between the separation-zone thickness (Ep5) and the leading-edge thickness (Ep0.2) for any section of an upper portion of the blade (14) extending to the apex (16) over a height (h) included between 35% and 100% of the total height of the blade (14).

2. The vane (10) according to claim 1, wherein, for each section plane (P) orthogonal to the blade axis (Z), the ratio (R) between the separation-zone thickness (Ep5) and the leading-edge thickness (Ep0.2) is included between 3.5 and 5.

3. The vane (10) according to claim 1, or wherein on a lower portion of the blade (14) extending from the foot (12) over a height (h) included between 0% and 35% of the total height (H) of the blade (14) measured between the foot (12) and the apex (16), for each section plane (P) of said lower portion, the ratio (R) between the separation-zone thickness (Ep5) and the leading-edge thickness (Ep0.2) is included between 3 and 8.

4. The vane (10) according to claim 1, wherein on an upper portion of the blade (14) extending to the apex (16) over a height (h) included between 35% and 100% of the total height (H) of the blade (14) measured between the foot (12) and the apex (16), for each section plane (P) of said upper portion, the ratio (R) between the separation-zone thickness (Ep5) and the leading-edge thickness (Ep0.2) is included between 2.5 and 5.

5. The vane (10) according to claim 1, wherein the blade (14) comprises, in each section plane (P) orthogonal to the blade axis (Z), a maximum thickness (Epmax), defined as the length of a third segment (S3) extending from the lower edge (22) to the upper edge (24) and cutting the median line (LS) perpendicularly at a third point (A3), for which the third segment (S3) length is a maximum over an extent of the median line (LS), and
wherein said third point (A3) is located at a distance from the leading edge (18), measured along the median line (LS), greater than or equal to 15% of the total length of the median line (LS), and advantageously included between 15% and 40% of the total length of the median line (LS).

6. The vane (10) according to claim 1, wherein the vane (10) is a rotor vane (3) mounted on a disk mobile in rotation around a main axis (X).

7. An unducted thruster (1) for aircraft, comprising:
at least one rotor (3) and one stator (5), separated along a main axis (X) of the thruster (1),
where at least one among the rotor (3) and the stator (5) comprises a plurality of vanes (10) according to claim 1, distributed circumferentially about the main axis (X).

8. The thruster (1) according to claim 7, wherein between the rotor (3) and the stator (3), the one placed upstream relative to the main axis (X) comprises at least two vanes (10) more than the one placed downstream.

9. The thruster (1) according to claim 7, wherein the stator (5) is arranged downstream and has a clipping rate included between 5% and 15% and particularly between 7% and 12%.

10. The thruster (1) according to claim 7, wherein each blade (14) has a chord length (C) defined as the maximum over an extent of the blade (14) for a distance between the leading edge (18) and the trailing edge (20) in a section plane (P) transverse to the blade axis (Z),
where the rotor (3) and the stator (5) have separations (E) between neighboring blades (14), measured along the circumferential direction,
wherein a solidity (7) of the rotor (3) and the stator (5), defined as the ratio of the chord length (C) over the separation (E) between the neighboring blades, is less than or equal to 3, and specifically less than or equal to 1 for the one placed the farthest upstream of the rotor (3) and the stator (5), relative to the main axis (Z).

11. The thruster (1) according to claim 7, wherein a ratio (S/T) between an axial distance(S) separating the rotor (3) and the stator (5) and an outer diameter (D) of the thruster (1) is included between 0.01 and 0.5, preferably between 0.15 and 0.35.

12. The thruster according to claim 7, wherein the plurality of vanes is between 3 and 25 vanes.

13. The thruster according to claim 7, wherein the plurality of vanes is between 8 and 16 vanes.
